(19) United States
(12) Patent Application Publication
(10) Pub. No.: US 2007/0011260 A1
(43) Pub. Date: Jan. 11, 2007

(54) Distributed streaming server

(76) Inventor: Fu-Sheng Chiu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,857

(22) Filed: Jul. 5, 2005

(51) Int. Cl. G06F 15/16

(52) U.S. Cl. 709/207

(57) ABSTRACT

A distributed streaming internet server system with multiple layers of servers, featuring data caching, file storage, and application servers. The system provides high reliability and high quality streaming media. The system is designed to be scalable so that additional capacity can be added easily as needed. Existing capacity use is optimized through reallocating user connections as necessary for load-balancing and failure management.

### BACKGROUND OF THE INVENTION

1. Field of the Invention

The present invention relates to an internet server. More specifically, the present invention discloses a multi-tier distributed internet service provider with streaming media management software, application services, and fail-over handoff management.

2. Description of the Prior Art

Traditionally, an internet service provider consisted of little more than a server with several modems attached to it. Referring to FIG. 1, a diagram of a prior-art internet service provider system 100, user computers 130˜132 used modems (not shown) to connect via phone lines 120˜122 to modems (not shown) inside the server 110. The server 110 connected to the rest of the internet 105 via a T-1 connection 108. This structure provided connections from the user computers 130˜132 to the internet 105 for data such as images and text emails.

However, this system 100 was prone to a number of problems and limitations. The number of connections was limited to the number of available modems in the server 110, and the server 110 was a single point of failure for all of the connections to the user computers 130˜132. Moreover, usage habits of users have changed with the invention of streaming audio and video media data, as well as high-bandwidth peer-to-peer software for sharing data; the traditional internet service provider system 100 has no ability to analyze data in order to reduce the overall communications load, and has limited bandwidth because of limited connectivity to the outside internet, resulting in slow service to users. Also, internet-based applications are being developed which will offload processing and programming from the user's computer to a centralized application server, and the traditional internet service provider system has no provisions for these applications.

Therefore there is need for an improved internet service provider structure which can manage server failure by transferring the user's connection to another server without cutting off the user's connection, which can increase data transfer speed through improved data management, and which can provide application management and execution services.

### SUMMARY OF THE INVENTION

To achieve these and other advantages and in order to overcome the disadvantages of the conventional method in accordance with the purpose of the invention as embodied and broadly described herein, the present invention provides an internet service provider system with a multi-tier architecture to enable fail-over and load-based handoff management of user connections, and to provide application servers for executing and storing internet applications.

The present invention further provides for caching of user data to reduce bandwidth usage and to service data requests faster via a high-speed server.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram showing a prior art internet service provider system;

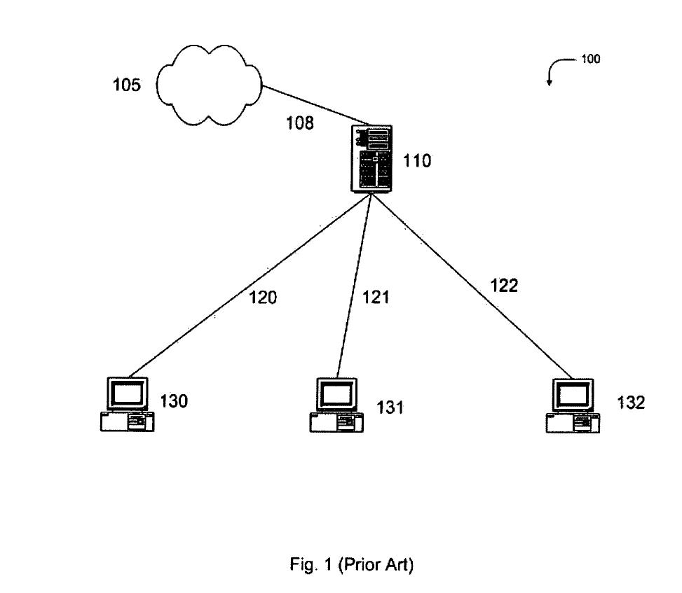

FIG. 2(a) is a block diagram illustrating an embodiment of an internet service provider system of the present invention;

FIG. 2(b) is a block diagram illustrating an embodiment of an internet service provider system of the present invention; and

FIG. 3 is a block diagram illustrating an embodiment of an internet service provider system of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

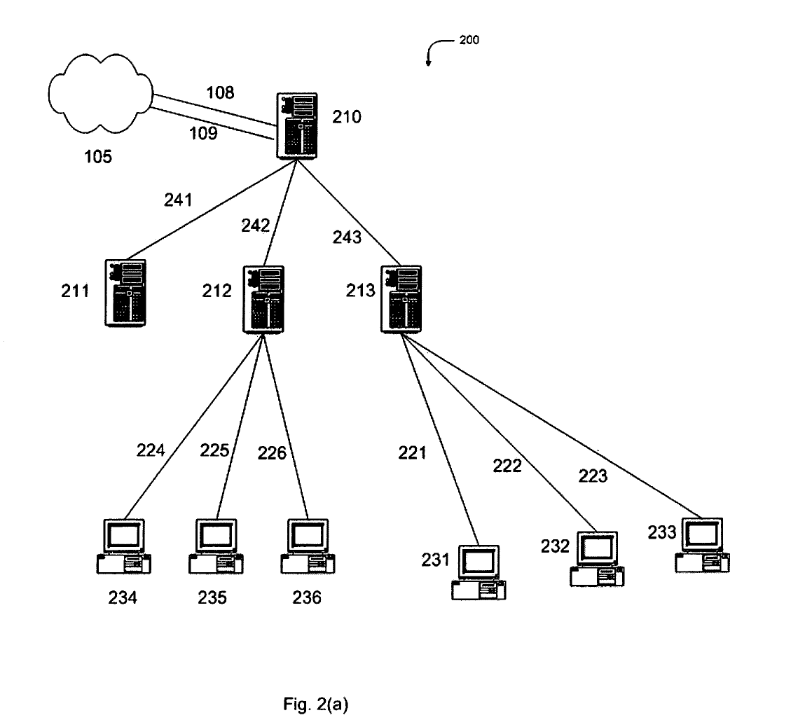

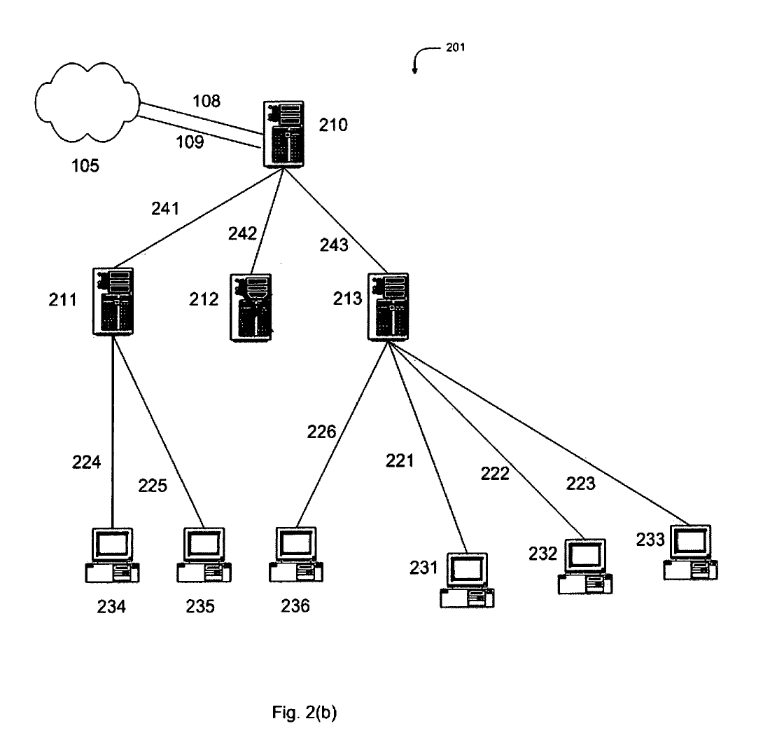

Please refer to FIG. 2a, a block diagram illustrating an embodiment of an internet service provider system 200 of the present invention. A primary server 210 is coupled to application servers 211˜213 via high-speed network connections 241˜243 such as Ethernet or token ring, or optionally by dedicated lines. The primary server is coupled to the internet 105 by one or more dedicated lines 108˜109. The application servers are coupled to user computers 231˜236 by high-speed network connections 221˜226 such as cable modem, frame relay, ADSL, iDSL, SDSL, and fixed wireless; and by legacy connections such as modem if necessary.

The application servers 211˜213 store user applications for use by the user computers 231˜236 and provide internet connections to the user computers via connections 221˜224. In addition to handling regular user data traffic, each application server 211˜213 sends a heartbeat signal to a monitor program on the primary server to signal that the particular application server is functioning. If a heartbeat signal is not received from a given application server in some given time period, the primary server attempts to communicate with that application server to determine whether that given application server is still functioning. If the primary server is unable to communicate with that given application server, the primary server then signals another application server to take over the connections to the user computers that were served by the given application server. Referring to FIG. 2(b) in combination with FIG. 2(a), in the event that application server 212 of internet service provider system 201 were to suffer a failure such as a hardware failure, primary server 210 can instruct application servers 211,213 to take over the user connections 224˜226 for user computers 234˜236. Thus the user does not lose connectivity and can continue to work. Connections can furthermore be allocated and reassigned depending on an application server's CPU load, by client computer bandwidth usage, or by number of connections.

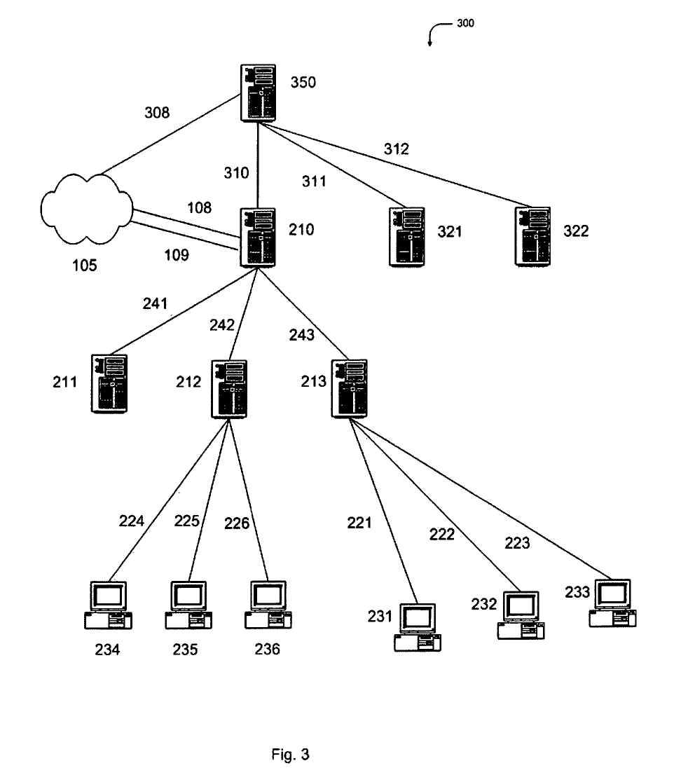

Please refer to FIG. 3, a block diagram showing another embodiment of the internet service provider system 300 of the present invention. FIG. 3 shows the internet service provider system 200 of FIG. 2 further comprising a main streaming server 310. This main streaming server 350 can serve other internet service providers 321˜322 which can be similar in structure to internet service provider system 200. Main streaming server 350 provides high bandwidth capacity to internet service providers 210,321,322 via high-bandwidth connections 310˜312 for serving large amounts of data such as streaming audio and video media. Main streaming server 350 further provides caching of these large streaming data sets so that if multiple users want to download the same data, the main streaming server does not need to retrieve the same data twice from the external internet 105 over connection 308. These servers can also cache data that the user is serving, for example via a peer-to-peer application such as Bittorrent, DC++, or other file sharing system. Additional main streaming servers can be added for redundancy and to provide additional bandwidth capacity. Through providing multiple layers of servers, streaming data can be buffered to provide a reliable stream of data for smooth audio or video playback without pauses or stalls. Each layer of servers can provide a buffer for a given stream, optimally ten to fifteen seconds of buffering time. Depth control allows for increasing or decreasing buffering time, controlling access delays by providing data on closer servers, and distributing the streaming data to route around bottlenecks, failures, and delays.

Application servers can further be used as internet data centers, to store user data for collaborative work, offsite backup, or for accessibility from any location.

This system thus provides a dramatic improvement over the limited prior art. Connections are more reliable and data is served to the user more quickly. Depth control allows any level of desired service to be configured for and provided, while distributing streamed data and connections improves reliability for the users.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. An internet service system comprising:
a primary server for managing a plurality of application servers;
a network for coupling the plurality of application servers to the primary server;
a server software program running on the primary server for detecting availability and resource usage on the plurality of application servers;
an application software program running on each application server of the plurality of application servers to report resource usage and availability to the server software program; and
a plurality of user computers coupled to the plurality of application servers by the network, said plurality of user computers sending a plurality of data requests through the network and receiving a plurality of response data.

2. The internet service system of claim 1 further comprising a media server coupled to the primary server and the application servers by the network, said media server comprising:
a data caching software program for analyzing the plurality of data requests and caching a subset of the plurality of response data; and
at least one data storage device for caching the subset of the plurality of response data.

3. The internet service system of claim 1, each application server further comprising:
a user data management software program for storing user data; and
at least one data storage device for storing the user data.

4. The internet service system of claim 1, the server software program further comprising:
a resource allocation module for collecting a resource usage data from the plurality of application servers, said resource usage data comprising at least a CPU usage percentage, a network usage percentage, and an availability indicator; and
a connection transfer module for transferring a user computer connection from a first application server of the plurality of application servers to a second application server of the plurality of application servers when the resource allocation module determines that the resource usage data from the first application server exceeds a threshold.

5. The internet service system of claim 1 further comprising a streaming management software program running on each application server of the plurality of application servers and on the media server, said streaming management software program comprising:
an input module to accept a streaming media data stream as input;
a buffering module to manage buffering levels of the streaming media data stream;
a caching module to determine whether the streaming media data stream should be cached; and
a storage module to store the streaming media data stream on the storage unit of the media server.

6. An internet service system comprising:
a plurality of servers comprising a primary server, a plurality of media servers, and a plurality of application servers;
a network for coupling the plurality of servers;
a server software program running on the primary server for detecting availability and resource usage on the plurality of application servers;
an application software program running on each application server of the plurality of application servers to report resource usage and availability to the server software program; and
a plurality of user computers coupled to the plurality of application servers by the network, said plurality of user computers sending a plurality of data requests through the network and receiving a plurality of response data.

7. The internet service system of claim 6 further comprising a media server coupled to the primary server and the application servers by the network, said media server comprising:
a data caching software program for analyzing the plurality of data requests and caching a subset of the plurality of response data; and
at least one data storage device for caching the subset of the plurality of response data.

8. The internet service system of claim 6, each application server further comprising:
a user data management software program for storing user data; and
at least one data storage device for storing the user data.

9. The internet service system of claim 6, server software program further comprising:
a resource allocation module for collecting a resource usage data from the plurality of application servers, said resource usage data comprising at least a CPU usage percentage, a network usage percentage, and an availability indicator; and
a connection transfer module for transferring a user computer connection from a first application server of the plurality of application servers to a second application server of the plurality of application servers when the resource allocation module determines that the resource usage data from the first application server exceeds a threshold.

10. The internet service system of claim 6 further comprising a streaming management software program running on each application server of the plurality of application servers and on the media server, said streaming management software program comprising:
an input module to accept a streaming media data stream as input;
a buffering module to manage buffering levels of the streaming media data stream;
a caching module to determine whether the streaming media data stream should be cached; and
a storage module to store the streaming media data stream on the storage unit of the media server.

11. An internet service system comprising:
a primary server for managing a plurality of application servers;
a network for coupling the plurality of application servers to the primary server;
a server software program running on the primary server for detecting availability and resource usage on the plurality of application servers; and
an application software program running on each application server of the plurality of application servers to report resource usage and availability to the server software program.

12. The internet service system of claim 11, further comprising:
a plurality of user computers coupled to the plurality of application servers by the network, said plurality of user computers sending a plurality of data requests through the network and receiving a plurality of response data.

13. The internet service system of claim 11 further comprising a media server coupled to the primary server and the application servers by the network, said media server comprising:
a data caching software program for analyzing the plurality of data requests and caching a subset of the plurality of response data; and
at least one data storage device for caching the subset of the plurality of response data.

14. The internet service system of claim 11, each application server further comprising:
a user data management software program for storing user data; and
at least one data storage device for storing the user data.

15. The internet service system of claim 11, the server software program further comprising:
a resource allocation module for collecting a resource usage data from the plurality of application servers, said resource usage data comprising at least a CPU usage percentage, a network usage percentage, and an availability indicator; and
a connection transfer module for transferring a user computer connection from a first application server of the plurality of application servers to a second application server of the plurality of application servers when the resource allocation module determines that the resource usage data from the first application server exceeds a threshold.

16. The internet service system of claim 11 further comprising a streaming management software program running on each application server of the plurality of application servers and on the media server, said streaming management software program comprising:
an input module to accept a streaming media data stream as input;
a buffering module to manage buffering levels of the streaming media data stream;
a caching module to determine whether the streaming media data stream should be cached; and
a storage module to store the streaming media data stream on the storage unit of the media server.
